(19) United States
(12) Patent Application Publication
(10) Pub. No.: US 2007/0070636 A1
(43) Pub. Date: Mar. 29, 2007

(54) LIGHTING DEVICE WITH REPLACEMENT LAMP STORAGE

(75) Inventor: George Michael Drake, Newnan, GA (US)

Correspondence Address: HAYNES AND BOONE, LLP, 901 MAIN STREET, SUITE 3100, DALLAS, TX, 75202, US

(73) Assignee: Cooper Technologies Company, Houston, TX (US)

(21) Appl. No.: 11/277,369

(22) Filed: Mar. 24, 2006

Related U.S. Application Data
(60) Provisional application No. 60/667,321, filed on Mar. 31, 2005.

(51) Int. Cl. F21V 19/00

(52) U.S. Cl. 362/382

(57) ABSTRACT

A lighting device with a replacement lamp storage for storing a plurality of replacement lamps.

### CROSS-REFERENCE TO RELATED APPLICATIONS

The present application claims priority to U.S. Provisional Application Ser. No. 60/667,321, attorney docket number 23667.164, filed on Mar. 31, 2005, the disclosure which is incorporated herein by reference.

### BACKGROUND

The present disclosure relates in general to lighting devices and in particular to a lighting device with a replacement lamp storage for storing a plurality of replacement lamps.

### BRIEF DESCRIPTION OF THE DRAWINGS

FIG. 1a is a perspective view illustrating an exemplary embodiment of a lighting device.

FIG. 1b is a perspective view illustrating an exemplary embodiment of the lighting device of FIG. 1a.

FIG. 2a is a perspective view illustrating an exemplary embodiment of a replacement lamp storage member used with the lighting device of FIGS. 1a and 1b.

FIG. 2b is a perspective view illustrating an exemplary embodiment of the replacement lamp storage member of FIG. 2a.

FIG. 3a is a flow chart illustrating an exemplary embodiment of a method for storing replacement lamps in a lighting device chassis.

FIG. 3b is a perspective view illustrating an exemplary embodiment of a plurality of lamps being positioned in the replacement lamp storage member of FIGS. 2a and 2b and the replacement lamp storage member being coupled to the lighting device chassis of FIGS. 1a and 1b.

FIG. 3c is a perspective view illustrating an exemplary embodiment of a plurality of lamps being positioned in the replacement lamp storage member of FIGS. 2a and 2b and the replacement lamp storage member being coupled to the lighting device chassis of FIGS. 1a and 1b.

FIG. 3d is a perspective view illustrating an exemplary embodiment of a plurality of lamps positioned in the replacement lamp storage member of FIGS. 2a and 2b.

FIG. 3e is a perspective view illustrating an exemplary embodiment of the replacement lamp storage member of FIGS. 2a and 2b positioned in the lighting device of FIGS. 1a and 1b.

FIG. 3f is a perspective view illustrating an exemplary embodiment of the replacement lamp storage member of FIGS. 2a and 2b positioned in the lighting device of FIGS. 1a and 1b.

FIG. 3g is a rear view illustrating an exemplary embodiment of the replacement lamp storage member of FIGS. 2a and 2b positioned in the lighting device of FIGS. 1a and 1b.

FIG. 3h is a side view illustrating an exemplary embodiment of the replacement lamp storage member of FIGS. 2a and 2b positioned in the lighting device of FIGS. 1a and 1b.

FIG. 3i is a front view illustrating an exemplary embodiment of the replacement lamp storage member of FIGS. 2a and 2b positioned in the lighting device of FIGS. 1a and 1b.

FIG. 3j is a top view illustrating an exemplary embodiment of the replacement lamp storage member of FIGS. 2a and 2b positioned in the lighting device of FIGS. 1a and 1b.

FIG. 3k is a cross sectional view illustrating an exemplary embodiment of the replacement lamp storage member of FIGS. 2a and 2b positioned in the lighting device of FIGS. 1a and 1b.

FIG. 4a is a perspective view illustrating an exemplary alternative embodiment of a lighting device including the replacement lamp storage member of FIGS. 2a and 2b.

FIG. 4b is a perspective view illustrating an exemplary alternative embodiment of the lighting device of FIG. 4a.

FIG. 5a is a perspective view illustrating an exemplary alternative embodiment of a replacement lamp storage member used with the lighting device of FIGS. 1a and 1b.

FIG. 5b is a perspective view illustrating an exemplary alternative embodiment of the replacement lamp storage member of FIG. 5a.

### DETAILED DESCRIPTION

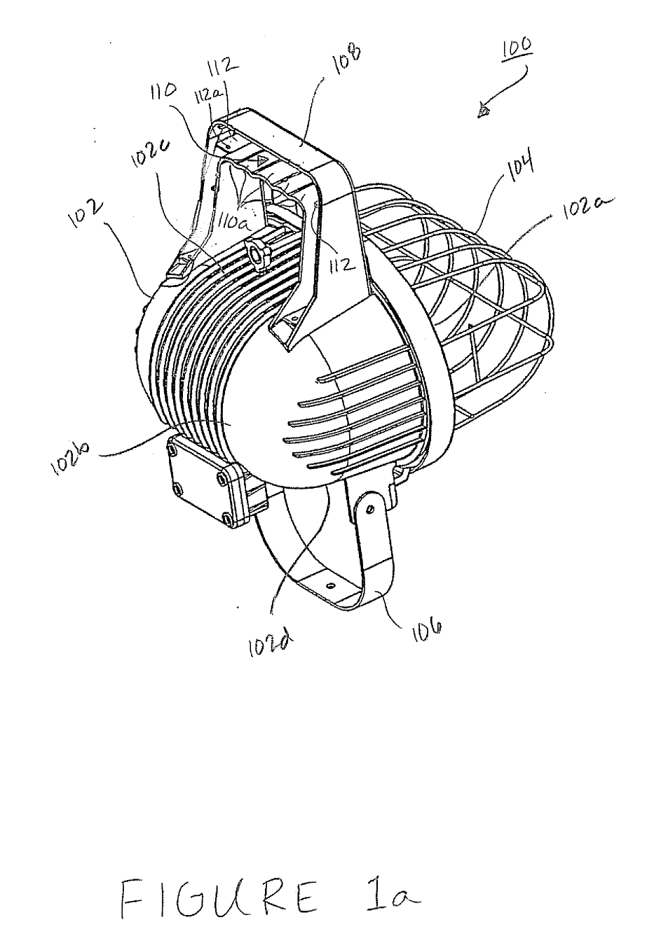

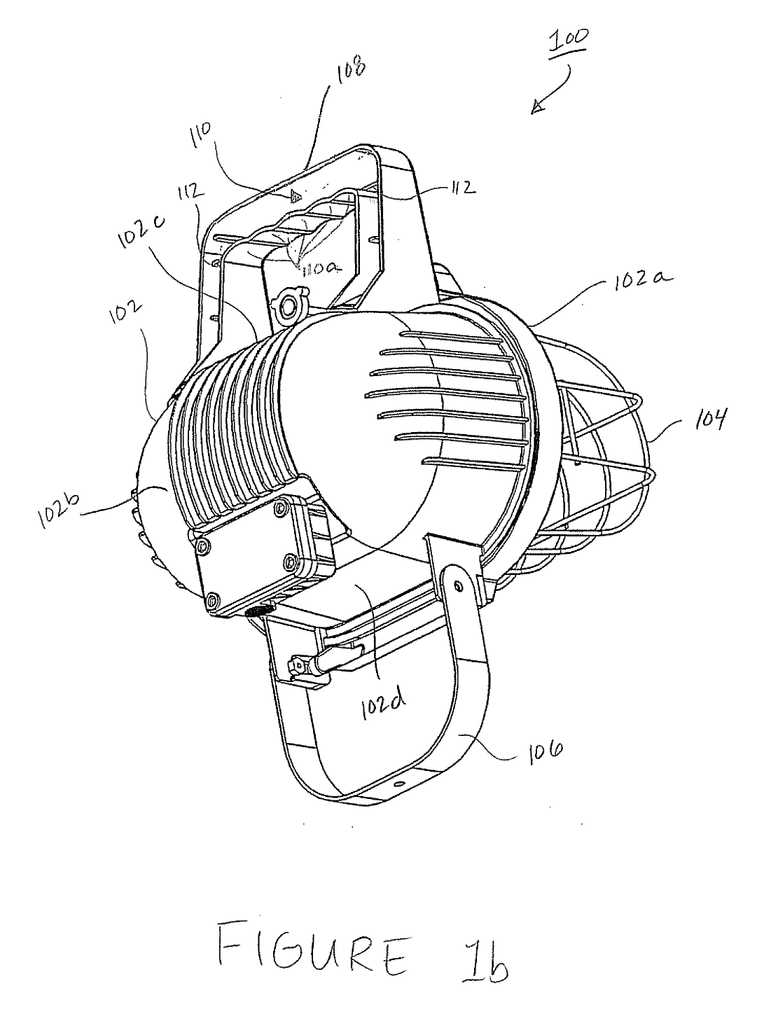

Referring now to FIGS. 1a and 1b, a lighting device 100 is illustrated. The lighting device 100 includes a lighting device chassis 102 having a front surface 102a, a rear surface 102b located opposite the front surface 102a, a top surface 102c extending between the front surface 102a and the rear surface 102b, and a bottom surface 102d located opposite the top surface 102c and extending between the front surface 102a and the rear surface 102b. A lighting device guard 104 extends from the front surface 102a of the lighting device chassis 102. A lighting device mount 106 extends from the bottom surface 102d of the lighting device chassis 102. A handle 108 extends from the top surface 102c of the lighting device chassis 102. The handle 108 defines a storage housing 110 extending across the width of the handle 108. A plurality of adjacent arcuate surfaces 110a are located on the handle 108 and adjacent the storage housing 110 such that the arcuate surfaces 110a help define the storage housing 110. A pair of securing surfaces 112 are located on the handle and adjacent opposing ends of the storage housing 110, each securing surface 112 including a securing member 112a extending from the securing surface 112.

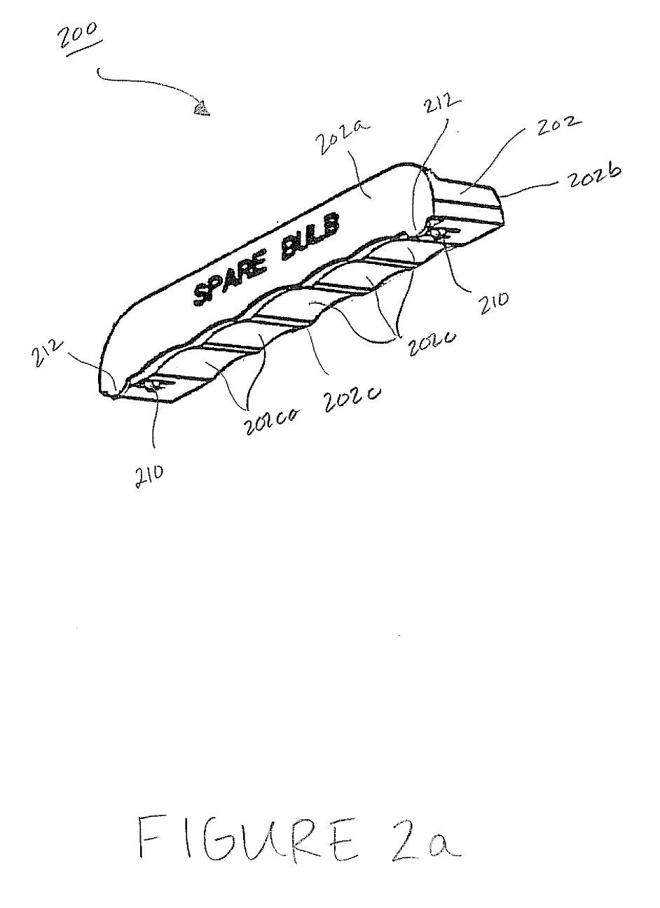

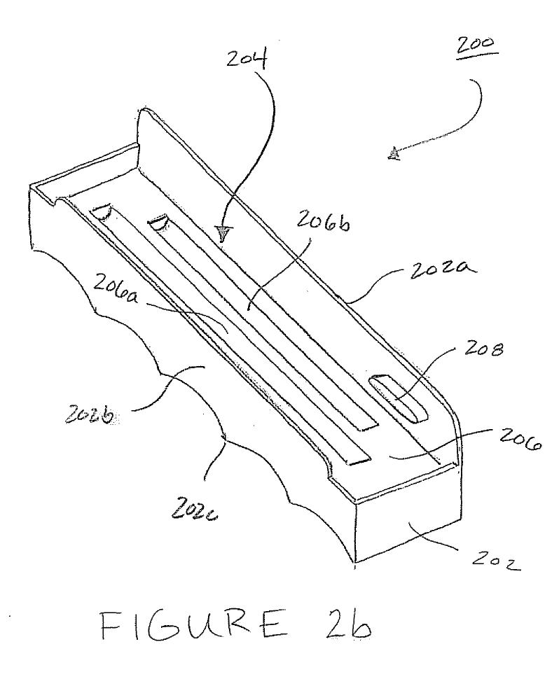

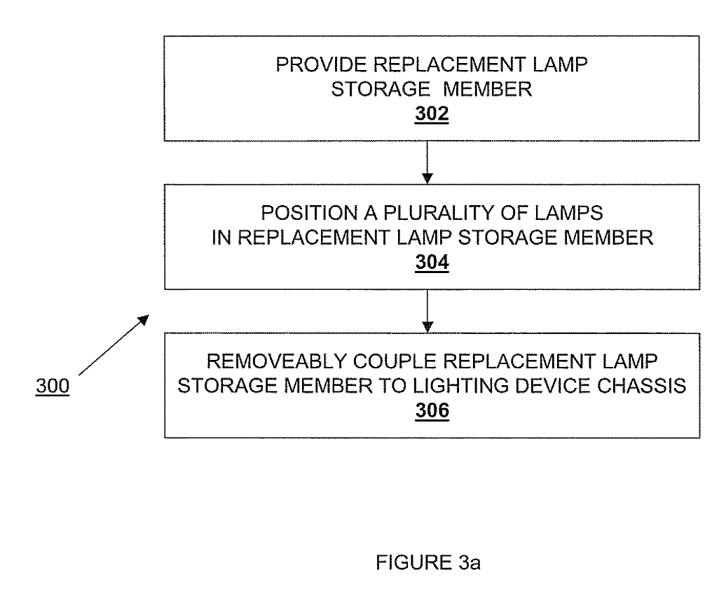

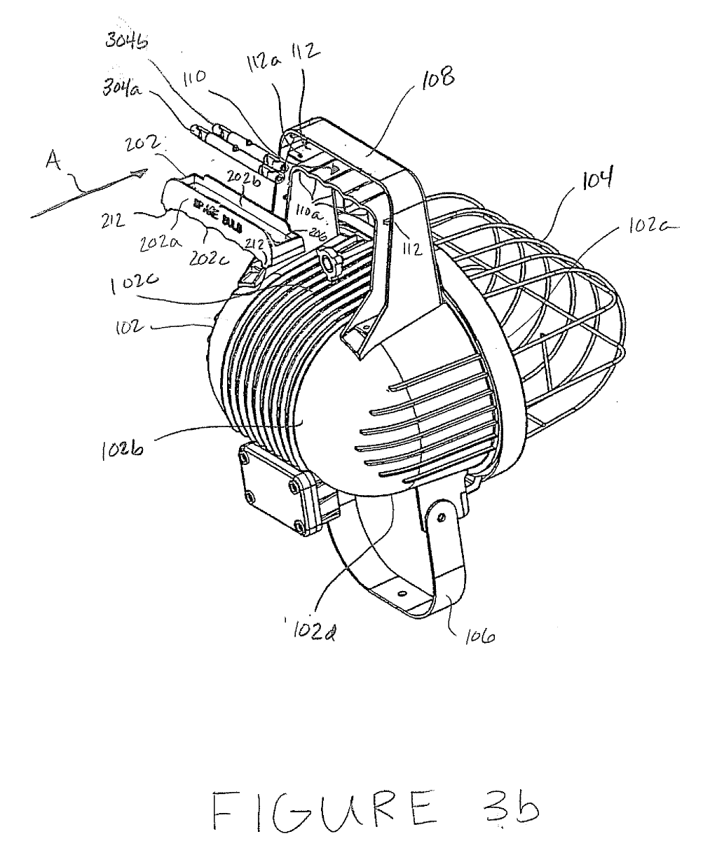

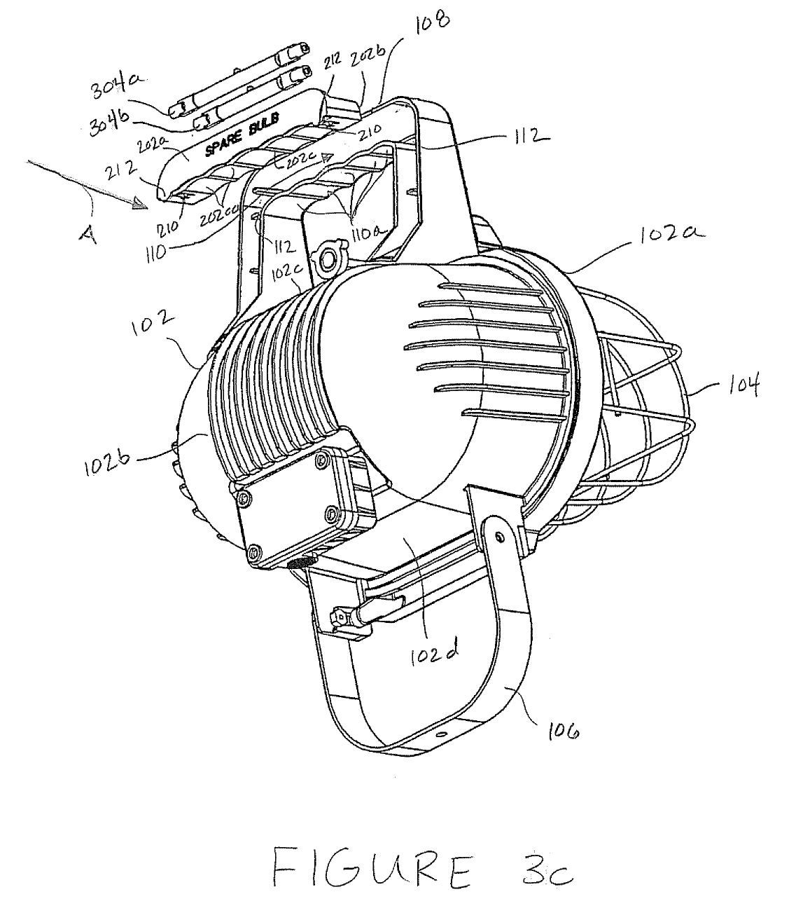

Referring now to FIGS. 2a and 2b, a replacement lamp storage member 200 is illustrated. The replacement lamp storage member 200 includes a base 202 having a front wall 202a, a rear wall 202b located opposite the front wall 202a, and a bottom wall 202c including a plurality of adjacent arcuate sections 202ca that extend between the front wall 202a and the rear wall 202b. A lamp housing 204 is defined by the replacement lamp storage member 200 between the front wall 202a, the rear wall 202b, and the bottom wall 202c. A lamp support member 206 is located in the lamp housing 204 and defines a pair of substantially parallel lamp channels 206a and 206b along its length. In an exemplary embodiment, the lamp support member 206 may be fabricated from a foam material, a rubber material, or a variety of other equivalent materials known in the art. In an exemplary embodiment, the lamp support member 206 may define additional lamp channels along its length. A lamp handling tool storage member 208 extends from the lamp support member 206 and is located adjacent the lamp housing 204. A pair of resilient securing members 210 extend from opposite ends of the bottom wall 202c. A pair of release tabs 212 extend from opposite ends of the front wall 202a adjacent the bottom wall 202c and respective securing members 210.

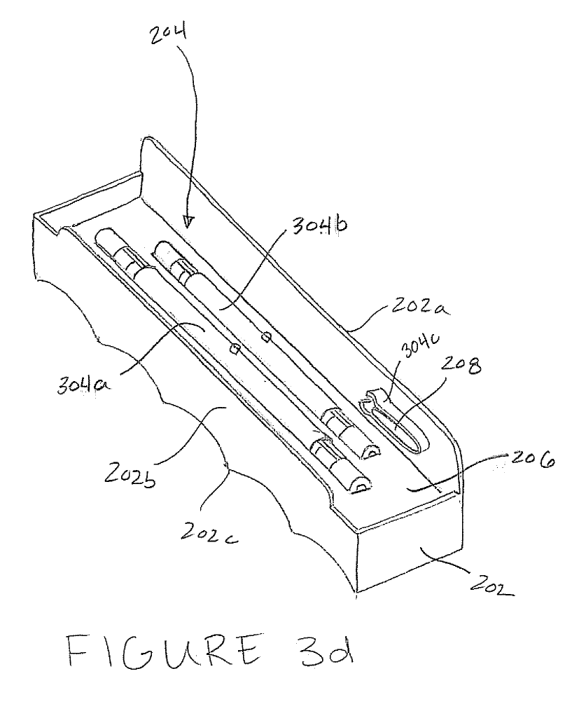

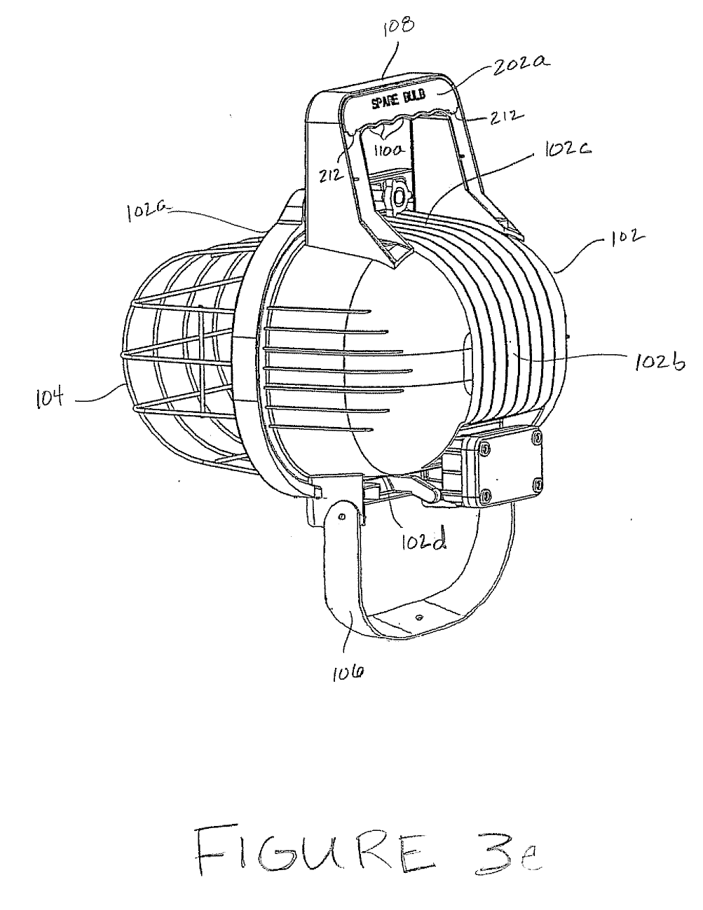

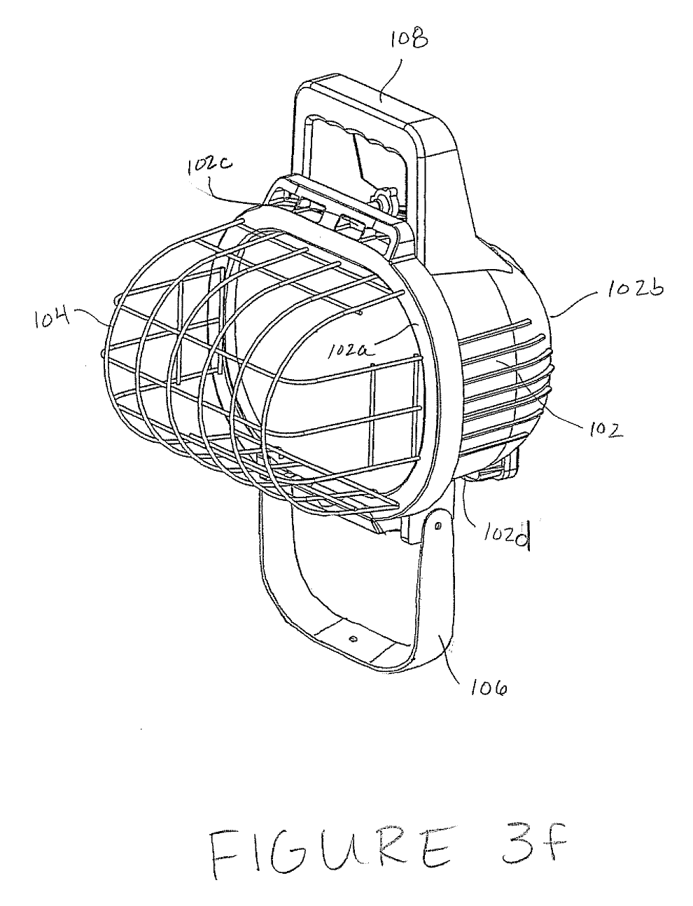

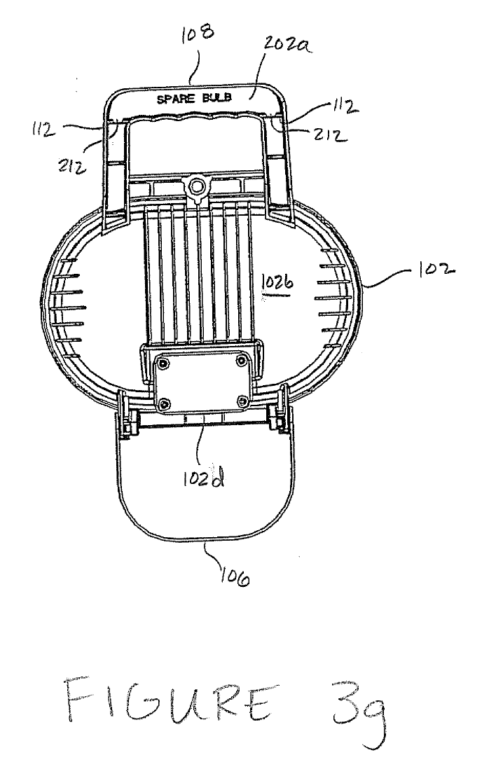

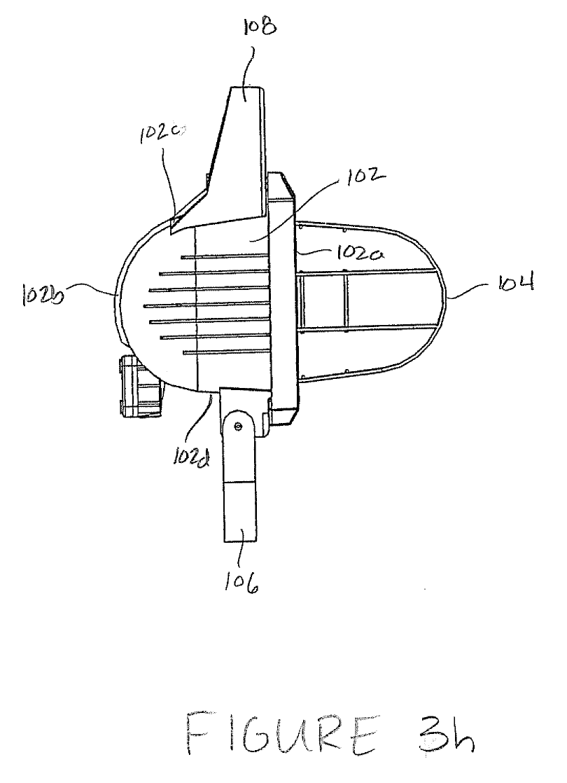

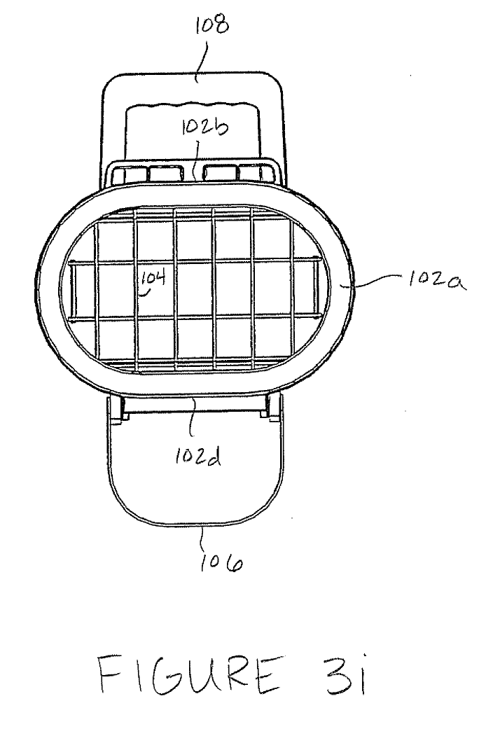

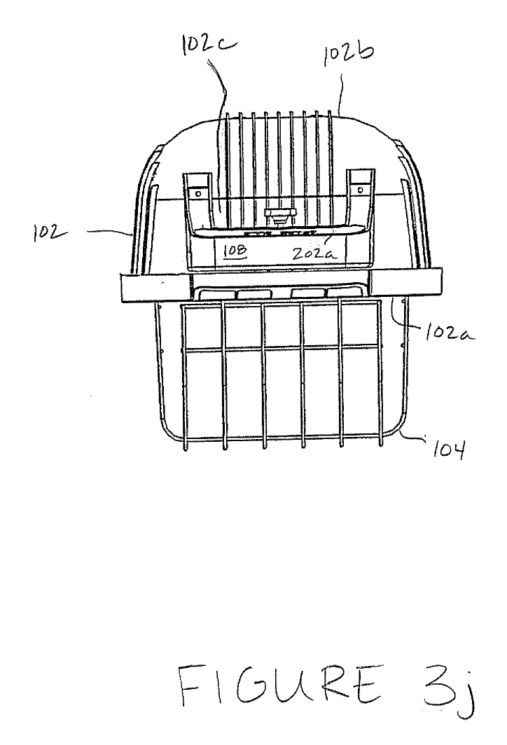

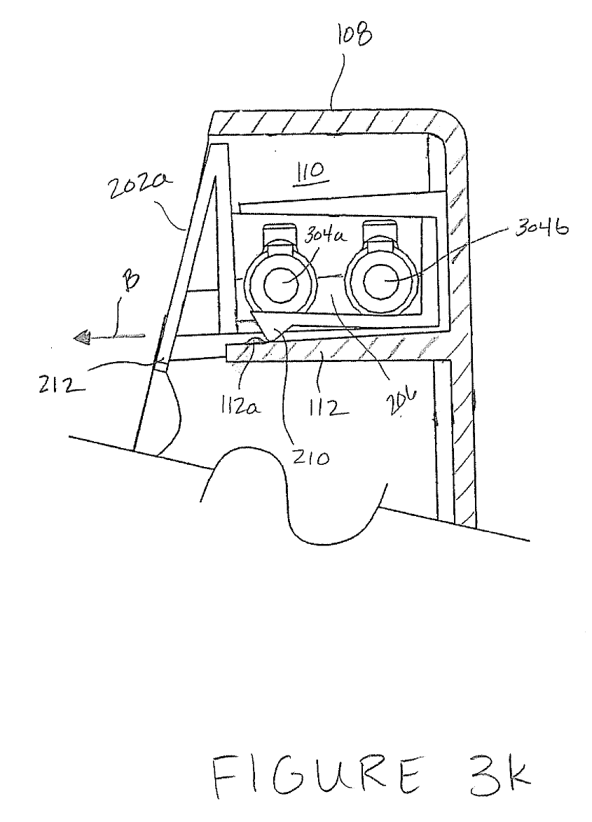

Referring now to FIGS. 1a, 1b, 2a, 2b, 3a, 3b, 3c, and 3d, a method 300 for storing replacement lamps in a lighting device chassis is illustrated. The method begins at step 310 where a replacement lamp storage member 200, described above with reference to FIGS. 2a and 2b, is provided. The method 300 then proceeds to step 304 where a plurality of lamps are positioned in the replacement lamps storage member 200. A pair of lamps 304a and 304b are provided. In an exemplary embodiment, the lamp 304a is larger than the lamp 304b. In an exemplary embodiment, the lamp 304a and the lamp 304b have different wattages. In an exemplary embodiment, the lamps 304a and 304b may include a protective wrap (not shown) to prevent the lamps 304a and 304b from being damaged by, for example, having skin oils deposited on the surface of the lamps 304a and 304b during lamp handling. In an exemplary embodiment, the lamps 304a and 304b may be halogen lamps, fluorescent lamps, incandescent lamps and/or a variety of other lamps known in the art. The lamps 304a and 304b are positioned above the replacement lamp storage member 200 such that the lamp 304a may be positioned in the lamp channel 206a on lamp support 206 and the lamp 304b may be positioned in the lamp channel 206b on lamp support 206, as illustrated in FIGS. 3b, 3c, and 3d. In an exemplary embodiment, a lamp handling tool 304c in coupled to the lamp handling tool storage member 208 and stored in the replacement lamp storage member 200, as illustrated in FIG. 3d. In an exemplary embodiment, the lamp handling tool 304c may be used to handle the lamps 304a and 304b such that the lamps are not damaged by, for example, having skin oils deposited on the surface of the lamps 304a and 304b during the positioning of step 304.

Referring now to FIGS. 1a, 1b, 2a, 2b, 3a, 3b, 3c, 3d, 3e, 3f, 3g, 3h, 3i, 3j, and 3k, the method 300 proceeds to step 306 where the replacement lamp storage member is removeably coupled to the lighting device chassis. The replacement lamp storage member 200 is positioned adjacent the storage housing 110 on the handle 108 of lighting device 100 such that the rear wall 202b is adjacent the storage housing 110 and the arcuate sections 202ca on the replacement lamp storage member 200 are adjacent the arcuate sections 110a on the handle 108, as illustrated in FIGS. 3b and 3c. The replacement lamp storage device 200 is then moved in a direction A such that the rear wall 202b of the replacement lamp storage member 200 enters the storage housing 110 on the handle 108 of lighting device 100. As the replacement lamp storage member 200 enters the storage housing 110, the securing members 210 extending from the bottom wall 202c of the replacement lamp storage member 200 resiliently deflect about the securing members 112a on the securing surfaces 112 such that the replacement lamp storage member 200 may be positioned in the storage housing 110 and the engagement of the securing members 210 and the securing members 112 secure the replacement lamp storage member 200 in the storage housing 110 on the lighting device 100, as illustrated in FIG. 3k. With the replacement lamp storage member 200 secured in the lighting device 100, the lamps 304a and 304b are stored in the lighting device 100 and the lighting device 100 may be carried around by the handle 108 and used to provide light, as illustrated in FIGS. 3e, 3f, 3g, 3h, 3k, and 3j. In an exemplary embodiment, the lighting device mount 106 may be mounted to a lighting device stand (not shown) or similar device known in the art in order to provide a support for the lighting device 100.

When a lamp in a lighting device 100 fails, or a different wattage is desired from the lighting device 100, the lamp 304a or the lamp 304b may be removed from the replacement lamp storage member 200 and coupled to the lighting device 100. The release tabs 212 may be moved in a direction B, as illustrated in FIG. 3k, resulting in the securing members 112a deflecting away from the securing members 210 such that the replacement lamp storage member 200 may be moved in a direction opposite the direction A and out of the storage housing 110. The lamp 304a and/or the lamp 304b may be removed from the lamp channels 206a and/or 206b, respectively, and coupled to the lighting device 100. In an exemplary embodiment, the lamp handling tool 304c may be used to handle the lamp 304a and/or the lamp 304b during the coupling of the lamp 304a and/or the lamp 304b to the lighting device 100 such that the lamp 304a and/or the lamp 304b are not damaged by, for example, having skin oils deposited on the surface of the lamp 304a and/or the lamp 304b during the handling of the lamp 304a and/or the lamp 304b. The replacement lamp storage member 200 may then be positioned back in the storage housing 110 on the handle 108 of the lighting device 100 in the same manner as described above.

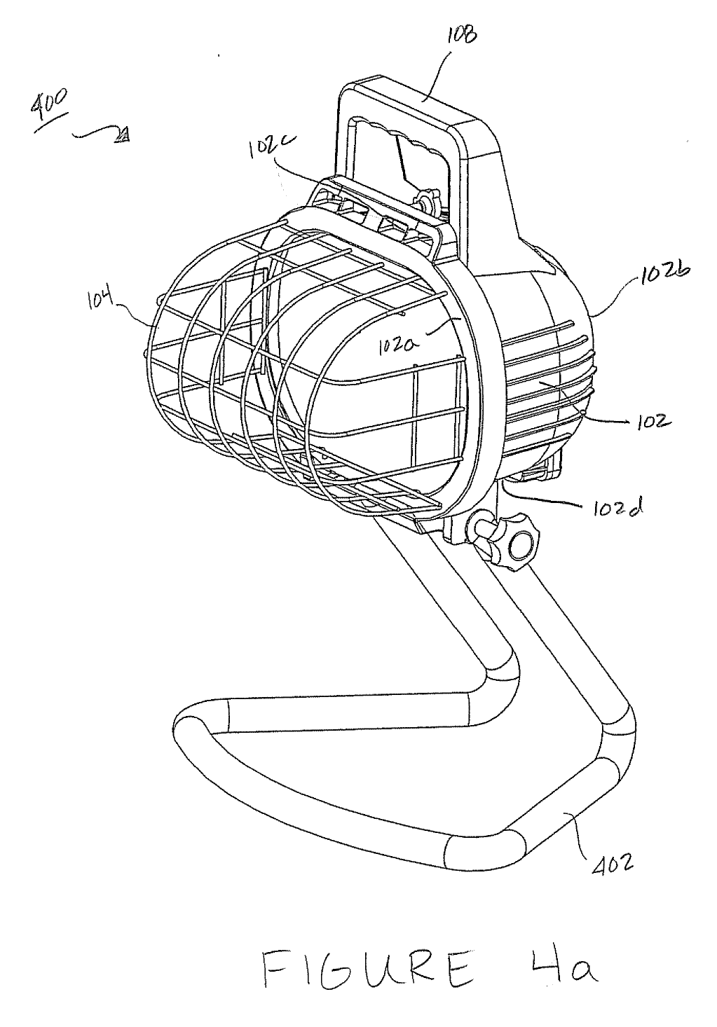

Referring now to FIGS. 4a and 4b, in an alternative embodiment, a lighting device 400 is substantially similar in design and operation to the lighting device 100, described above with reference to FIGS. 1a, 1b, 2a, 2b, 3a, 3b, 3c, 3d, 3e, 3f, 3g, 3, 3i, 3j, and 3k, with the provision of a lighting device chassis stand 402 replacing the lighting device mount 106. The lighting device chassis stand 402 allows the lighting device 400 to be carried around by the handle 108 and then supported by the lighting device chassis stand 402 in order to allow the lighting device 400 to provide light. Furthermore, the lighting device chassis stand 402 includes a tool storage member 404 defining a tool storage housing 404a extending from a leg of the lighting device chassis stand 402. In an embodiment, the tool storage member 404a is operable to store one or more tools in the tool storage housing 404a such as, for example, a wrench, a screwdriver, a leveling device, and/or a variety of other tools known in the art.

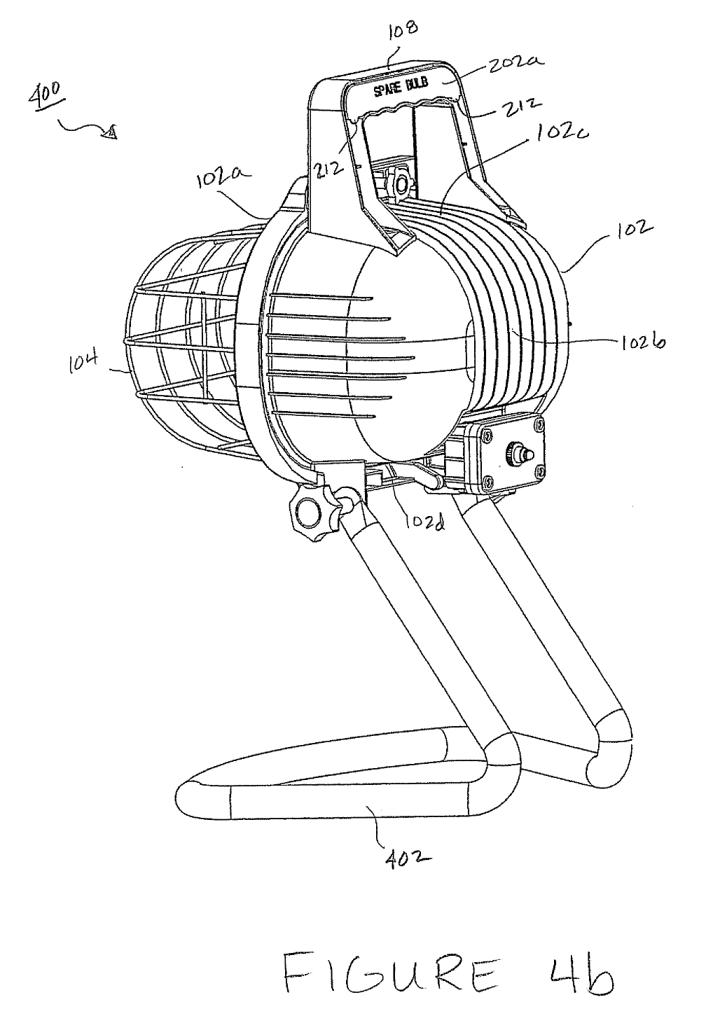

Referring now to FIGS. 5a and 5b, in an alternative embodiment, a replacement lamp storage member 500 is substantially similar in design and operation to the replacement lamp storage member 200, described above with reference to FIGS. 2a and 2b, with the provision of a dividing wall 502 replacing the lamp support member 206. The dividing wall 502 defines a plurality of lamp housings 502a and 502b in the lamp housing 204 such that the lamps 304a and 304b may be positioned and stored in the lamp housings 502a and 502b, respectively, as illustrated in FIG. 5b.

A lighting device has been described that includes a lighting device chassis, a storage housing defined by the lighting device chassis, and a replacement lamp storage member operable to removeably couple to the lighting device chassis in the storage housing, whereby the replacement lamp storage member defines a lamp housing operable to store a plurality of replacement lamps for use in the lighting device. In an exemplary embodiment, the lighting device chassis comprises a handle, whereby the storage housing is defined by the handle. In an exemplary embodiment, a lamp support member defines a plurality of lamp channels located in the lamp housing. In an exemplary embodiment, a lamp handling tool storage member is located in the lamp housing. In an exemplary embodiment, a plurality of lamps are located in the lamp housing. In an exemplary embodiment, a lamp handling tool is located in the lamp housing. In an exemplary embodiment, the lamp housing is operable to store a plurality of replacement lamps having different wattages for use in the lighting device. In an exemplary embodiment, a securing member is located on the replacement lamp storage member and operable to engage the lighting device chassis in order to secure the replacement lamp storage member to the lighting device chassis. In an exemplary embodiment, a lighting device chassis stand is coupled to the lighting device chassis and comprises a tool storage member.

A lighting device has been described that includes a lighting device chassis, and means for storing a plurality of means for providing light, the means for storing operable to removeably couple to the lighting device chassis. In an exemplary embodiment, the lighting device chassis comprises a means for carrying the lighting device chassis, whereby the means for storing a plurality of means for providing light is operable to removeably couple to the means for carrying the lighting device chassis. In an exemplary embodiment, means for supporting a plurality of means for providing light is located in the means for storing a plurality of means for providing light. In an exemplary embodiment, the means for storing a plurality of means for providing light comprises means for storing a means for handling a means for providing light. In an exemplary embodiment, a plurality of means for providing light are located in the means for storing a plurality of means for providing light. In an exemplary embodiment, means for handling a means for providing light is located in the means for storing a plurality of means for providing light. In an exemplary embodiment, the means for storing a plurality of means for providing light is operable to store a plurality of means for providing light having different wattages. In an exemplary embodiment, the device further includes means for securing the means for storing a plurality of means for providing light to the lighting device chassis. In an exemplary embodiment, means for supporting the lighting device chassis is coupled to the lighting device chassis, the means for support comprising a means for storing a tool.

A method for storing replacement lamps in a lighting device chassis has been described that includes providing a replacement lamp storage member, positioning a plurality of replacement lamps in the replacement lamp storage member, and removeably coupling the replacement lamp storage member to a lighting device chassis. In an exemplary embodiment, the positioning comprises positioning a plurality of replacement lamps having different wattages in the replacement lamp storage member. In an exemplary embodiment, the positioning comprises positioning the plurality of replacement lamps in a plurality of lamp channels defined by a lamp support member located in the replacement lamp storage member. In an exemplary embodiment, the removeably coupling comprises securing the replacement lamp storage member to the lighting device chassis. In an exemplary embodiment, the method further includes removing a replacement lamp from the replacement lamp storage member and coupling the replacement lamp to a lighting device in the lighting device chassis. In an exemplary embodiment, the removing comprises using a lamp handling tool located in the replacement lamp storage member to remove the replacement lamp from the replacement lamp storage member. In an exemplary embodiment, the method further includes supporting the lighting device chassis with a lighting device chassis stand, and storing a tool in a tool storage member on the lighting device chassis stand.

A lighting device has been described that includes a lighting device chassis comprising a handle, a storage housing defined by the handle on the lighting device chassis, a replacement lamp storage member operable to removeably couple to the handle in the storage housing, whereby the replacement lamp storage member defines a lamp housing operable to store a plurality of replacement lamps having different wattages for use in the lighting device, and a securing member located on the replacement lamp storage member and operable to engage the lighting device chassis in order to secure the replacement lamp storage member to the lighting device chassis.

A lighting device has been described that includes a lighting device chassis comprising a means for carrying the lighting device chassis, means for storing a plurality of means for providing light having different wattages, the means for storing operable to removeably couple to the means for carrying the lighting device chassis on the lighting device chassis, and means for securing the means for storing a plurality of means for providing light to the lighting device chassis.

A method for storing replacement lamps in a lighting device chassis has been described that includes providing a replacement lamp storage member, positioning a plurality of replacement lamps having different wattages in the replacement lamp storage member, removeably coupling the replacement lamp storage member to a lighting device chassis, wherein the removeably coupling comprises securing the replacement lamp storage member to the lighting device chassis, and removing a replacement lamp from the replacement lamp storage member and coupling the replacement lamp to a lighting device in the lighting device chassis.

It is understood that variations may be made in the foregoing without departing from the scope of the disclosure.

Any foregoing spatial references such as, for example, “upper,” “lower,” “above,” “below,” “rear,” “between,” “vertical,” “angular,” etc., are for the purpose of illustration only and do not limit the specific orientation or location of the structure described above.

In several exemplary embodiments, it is understood that one or more of the operational steps in each embodiment may be omitted. Moreover, in some instances, some features of the present disclosure may be employed without a corresponding use of the other features. Moreover, it is understood that one or more of the above-described embodiments and/or variations may be combined in whole or in part with any one or more of the other above-described embodiments and/or variations.

Although exemplary embodiments of this disclosure have been described in detail above, those skilled in the art will readily appreciate that many other modifications, changes and/or substitutions are possible in the exemplary embodiments without materially departing from the novel teachings and advantages of this disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A lighting device, comprising:
a lighting device chassis;
a storage housing defined by the lighting device chassis; and
a replacement lamp storage member operable to removeably couple to the lighting device chassis in the storage housing, whereby the replacement lamp storage member defines a lamp housing operable to store a plurality of replacement lamps for use in the lighting device.

2. The device of claim 1, wherein the lighting device chassis comprises a handle, whereby the storage housing is defined by the handle.

3. The device of claim 1, further comprising:
a lamp support member defining a plurality of lamp channels located in the lamp housing.

4. The device of claim 1, further comprising:
a lamp handling tool storage member located in the lamp housing.

5. The device of claim 1, further comprising:
a plurality of lamps located in the lamp housing.

6. The device of claim 4, further comprising:
a lamp handling tool located in the lamp housing.

7. The device of claim 1, wherein the lamp housing is operable to store a plurality of replacement lamps having different wattages for use in the lighting device.

8. The device of claim 1, further comprising:
a securing member located on the replacement lamp storage member and operable to engage the lighting device chassis in order to secure the replacement lamp storage member to the lighting device chassis.

9. The device of claim 1, further comprising:
a lighting device chassis stand coupled to the lighting device chassis and comprising a tool storage member.

10. A lighting device, comprising:
a lighting device chassis; and
means for storing a plurality of means for providing light, the means for storing operable to removeably couple to the lighting device chassis.

11. The device of claim 10, wherein the lighting device chassis comprises a means for carrying the lighting device chassis, whereby the means for storing a plurality of means for providing light is operable to removeably couple to the means for carrying the lighting device chassis.

12. The device of claim 10, further comprising:
means for supporting a plurality of means for providing light located in the means for storing a plurality of means for providing light.

13. The device of claim 10, wherein the means for storing a plurality of means for providing light comprises means for storing a means for handling a means for providing light.

14. The device of claim 10, further comprising:
a plurality of means for providing light located in the means for storing a plurality of means for providing light.

15. The device of claim 13, further comprising:
means for handling a means for providing light located in the means for storing a plurality of means for providing light.

16. The device of claim 10, wherein the means for storing a plurality of means for providing light is operable to store a plurality of means for providing light having different wattages.

17. The device of claim 10, further comprising:
means for securing the means for storing a plurality of means for providing light to the lighting device chassis.

18. The device of claim 10, further comprising:
means for supporting the lighting device chassis coupled to the lighting device chassis, the means for support comprising a means for storing a tool.

19. A method for storing replacement lamps in a lighting device chassis, comprising:
providing a replacement lamp storage member;
positioning a plurality of replacement lamps in the replacement lamp storage member; and
removeably coupling the replacement lamp storage member to a lighting device chassis.

20. The method of claim 19, wherein the positioning comprises positioning a plurality of replacement lamps having different wattages in the replacement lamp storage member.

21. The method of claim 19, wherein the positioning comprises positioning the plurality of replacement lamps in a plurality of lamp channels defined by a lamp support member located in the replacement lamp storage member.

22. The method of claim 19, wherein the removeably coupling comprises securing the replacement lamp storage member to the lighting device chassis.

23. The method of claim 19, further comprising:
removing a replacement lamp from the replacement lamp storage member and coupling the replacement lamp to a lighting device in the lighting device chassis.

24. The method of claim 23, wherein the removing comprises using a lamp handling tool located in the replacement lamp storage member to remove the replacement lamp from the replacement lamp storage member.

25. The method of claim 19, further comprising:
supporting the lighting device chassis with a lighting device chassis stand; and
storing a tool in a tool storage member on the lighting device chassis stand.

26. A lighting device, comprising:
a lighting device chassis comprising a handle;
a storage housing defined by the handle on the lighting device chassis;
a replacement lamp storage member operable to removeably couple to the handle in the storage housing, whereby the replacement lamp storage member defines a lamp housing operable to store a plurality of replacement lamps having different wattages for use in the lighting device; and
a securing member located on the replacement lamp storage member and operable to engage the lighting device chassis in order to secure the replacement lamp storage member to the lighting device chassis.

27. A lighting device, comprising:
a lighting device chassis comprising a means for carrying the lighting device chassis;
means for storing a plurality of means for providing light having different wattages, the means for storing operable to removeably couple to the means for carrying the lighting device chassis on the lighting device chassis; and
means for securing the means for storing a plurality of means for providing light to the lighting device chassis.

28. A method for storing replacement lamps in a lighting device chassis, comprising:
providing a replacement lamp storage member;
positioning a plurality of replacement lamps having different wattages in the replacement lamp storage member;
removeably coupling the replacement lamp storage member to a lighting device chassis, wherein the removeably coupling comprises securing the replacement lamp storage member to the lighting device chassis; and
removing a replacement lamp from the replacement lamp storage member and coupling the replacement lamp to a lighting device in the lighting device chassis.
